(19) United States
(12) Patent Application Publication
(10) Pub. No.: US 2026/0213646 A1
(43) Pub. Date: Jul. 23, 2026

(54) OUTPUT CURRENT PROTECTION CONTROLLER USING DETECTION THRESHOLD VOLTAGE ADAPTIVELY ADJUSTED ACCORDING TO TEMPERATURE VARIATION AND ASSOCIATED METHOD

(71) Applicant: CYNTEC CO., LTD., Hsinchu (TW)

(72) Inventor: Nang Ching Yeung, Hsinchu (TW)

(73) Assignee: CYNTEC CO., LTD., Hsinchu (TW)

(21) Appl. No.: 19/329,492

(22) Filed: Sep. 15, 2025

Related U.S. Application Data
(60) Provisional application No. 63/746,270, filed on Jan. 17, 2025.

(51) Int. Cl. H02M 1/32; H02M 1/00; H02M 3/158

(52) U.S. Cl. CPC H02M 1/32; H02M 1/0009; H02M 3/158

(57) ABSTRACT

An output current protection controller includes a comparator circuit and a threshold voltage generator circuit. The comparator circuit compares a current sensing signal with a detection threshold voltage to generate a control signal that controls output current protection of a switching regulator circuit. The current sensing signal is indicative of an output current of the switching regulator circuit. The threshold voltage generator circuit adaptively adjusts the detection threshold voltage according to temperature variation.

### CROSS REFERENCE TO RELATED APPLICATIONS

This application claims the benefit of U.S. Provisional Application No. 63/746,270, filed on Jan. 17, 2025. The content of the application is incorporated herein by reference.

### BACKGROUND OF THE DISCLOSURE

### 1. Field of the Disclosure

The present disclosure relates to a voltage regulator design, and more particularly, to an output current protection controller using a detection threshold voltage adaptively adjusted according to temperature variation and an associated method.

### 2. Description of the Prior Art

In an electronic device, a voltage regulator is used to supply stable power to electronic loads. The voltage regulator is typically designed to maintain an output voltage within specified limits even as an electrical load supported by the voltage regulator changes or as the supply power fluctuates. For example, the voltage regulator may be a switching regulator circuit such as a buck converter which generates an output voltage lower than an input voltage. In certain applications, the switching regulator circuit is equipped with an over current protection (OCP) function to prevent an output current (i.e., an inductor current) from exceeding a current limit setting. Hence, current sensing is necessitated by the OCP function. For example, a current flowing through a power switch of the switching regulator circuit can be sensed for generating a current sensing signal indicative of the output current of the switching regulator circuit. However, due to certain factors, the current sensing signal may fail to indicate an actual value of the output current, and the OCP function may fail to work as intended.

### SUMMARY OF THE DISCLOSURE

One of the objectives of the claimed disclosure is to provide an output current protection controller using a detection threshold voltage adaptively adjusted according to temperature variation and an associated method.

According to a first aspect of the present disclosure, an exemplary output current protection controller is disclosed. The exemplary output current protection controller includes a comparator circuit and a threshold voltage generator circuit. The comparator circuit is configured to compare a current sensing signal with a detection threshold voltage to generate a control signal that controls output current protection of a switching regulator circuit, wherein the current sensing signal is indicative of an output current of the switching regulator circuit. The threshold voltage generator circuit is configured to adaptively adjust the detection threshold voltage according to temperature variation.

According to a second aspect of the present disclosure, an exemplary output current protection method is disclosed. The exemplary output current protection method includes: comparing a current sensing signal with a detection threshold voltage to generate a control signal that controls output current protection of a switching regulator circuit, wherein the current sensing signal is indicative of an output current of the switching regulator circuit; and adaptively adjusting the detection threshold voltage according to temperature variation.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a switching regulator circuit with the proposed output current protection controller design according to an embodiment of the present disclosure.

FIG. 2 is a diagram illustrating a first scenario in which the proposed adaptive adjustment of the detection threshold voltage is disabled under an I2=0 condition according to an embodiment of the present disclosure.

FIG. 3 is a diagram illustrating a second scenario in which the proposed adaptive adjustment of the detection threshold voltage is disabled under an I2≠0 condition according to an embodiment of the present disclosure.

FIG. 4 is a flowchart illustrating an output current protection method according to an embodiment of the present disclosure.

FIG. 5 is a diagram illustrating a forward voltage detection circuit according to an embodiment of the present disclosure.

FIG. 6 is a diagram illustrating a third scenario in which the proposed adaptive adjustment of the detection threshold voltage is enabled under an I2≠0 condition according to an embodiment of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

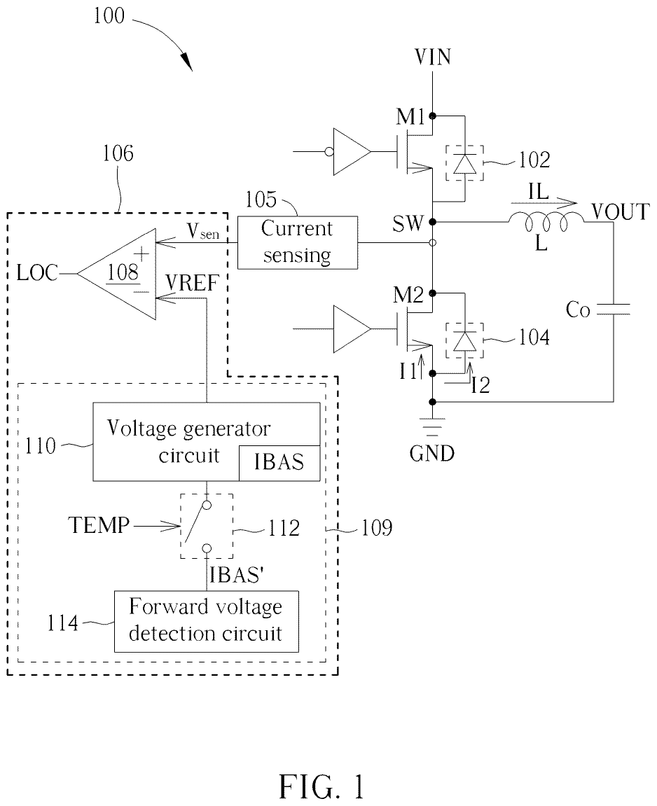

FIG. 1 is a diagram illustrating a switching regulator

circuit with the proposed output current protection controller design according to an embodiment of the present disclosure. In this embodiment, the switching regulator circuit 100 may be a buck converter circuit used for converting an input voltage VIN into an output voltage VOUT (VOUT<VIN). The input voltage VIN may be provided from a power source (not shown) such as a battery. The output voltage VOUT may be supplied to a load device (not shown). The switching regulator circuit 100 includes an inductor L, an output capacitor C₀, a high-side power switch M1, a low-side power switch M2, a current sensing circuit (labeled by “current sensing”) 105, and an output current protection controller 106.

The high-side (HS) power switch M1 may be implemented using an N-channel metal-oxide-semiconductor (NMOS) transistor. Due to inherent characteristics of the NMOS transistor, the high-side power switch M1 has a body diode 102 with an anode coupled to a source terminal and a cathode coupled to a drain terminal. The low-side (LS) power switch M2 may be implemented using an NMOS transistor. Due to inherent characteristics of the NMOS transistor, the low-side power switch M2 has a body diode 104 with an anode coupled to a source terminal and a cathode coupled to a drain terminal. The high-side power switch M1 and the low-side power switch M2 are series-connected between a first voltage node (e.g., input voltage VIN) and a second voltage node (e.g., ground voltage GND). Specifically, the high-side power switch M1 is coupled between the first voltage node (e.g., input voltage VIN) and a switch node SW, and the low-side power switch M2 is coupled between the switch node SW and the second voltage node (e.g., ground voltage GND), where the switch node SW is coupled to one end of the inductor L.

The output current protection controller 106 includes a comparator circuit 108 and a threshold voltage generator circuit 109. For better comprehension of technical features of the present disclosure, the following assumes that the output current protection controller 106 is an over current protection (OCP) controller that is used to control whether or not an OCP function should be enabled to prevent an output current (i.e., an inductor current IL) from exceeding a current limit setting. The comparator circuit 108 is configured to compare a current sensing signal Vₛₑₙ with a detection threshold voltage VREF to generate a control signal LOC that controls output current protection (e.g., OCP) of the switching regulator circuit 100. The current sensing signal Vₛₑₙ is derived from current sensing of the output current (i.e., inductor current IL) of the switching regulator circuit 100. Specifically, the current sensing signal Vₛₑₙ is a voltage signal indicative of magnitude of the output current (i.e., inductor current IL) of the switching regulator circuit 100. In this embodiment, the current sensing signal Vₛₑₙ is generated from the current sensing circuit 105 when the high-side power switch M1 is switched off and the low-side power switch M2 is switched on. For example, the high-side power switch M1 and the low-side power switch M2 may switch on and off alternately during a period. That is, when the high-side power switch M1 is switched on (i.e., conductive), the low-side power switch M2 is switched off (i.e., non-conductive), and vice versa.

It should be noted that the present disclosure has no limitations on actual implementation of the current sensing circuit 105. In practice, any current sensing scheme capable of generating a voltage representative of an output current of the switching regulator circuit 100 (e.g., a voltage representative of a current passing through the low-side power switch M2 when the high-side power switch M1 is switched off) may be adopted by the current sensing circuit 105. For example, the current sensing circuit 105 may have a sensing MOS transistor (e.g., an NMOS transistor), where a gate terminal of the sensing MOS transistor (e.g., NMOS transistor) is coupled to a gate terminal of the low-side power switch (e.g., NMOS transistor) M2, and a drain terminal of the sensing MOS transistor (e.g., NMOS transistor) is coupled to a drain terminal of the low-side power switch (e.g., NMOS transistor) M2.

Consider a case where the detection threshold voltage VREF is set by a static voltage regardless of temperature variation. The comparator circuit 108 may fail to detect occurrence of an over current (OC) event when the current I1 passing through the switched-on low-side power switch (e.g., NMOS transistor) M2 is large. For example, the switching regulator circuit (e.g., buck converter circuit) 100 may not need power switches with low on-resistance RON. As a result, high RON of the low-side power switch M2 may cause a current sensing problem. For example, when the current I1 passing through the switched-on low-side power switch (e.g., NMOS transistor) M2 is large, the voltage drop I1*RON between the drain terminal and the source terminal of the low-side power switch M2 may be larger than a forward voltage VF of the body diode 104. The output current (i.e., inductor current IL) may flow through both of the NMOS transistor and its body diode 104. There is a sensing error between the current sensing signal Vₛₑₙ indicative of the current I1 flowing through the NMOS transistor and an actual value of the output current (i.e., inductor current IL) which is a sum of the current I1 flowing through the NMOS transistor and the current I2 flowing through the forward-biased body diode 104.

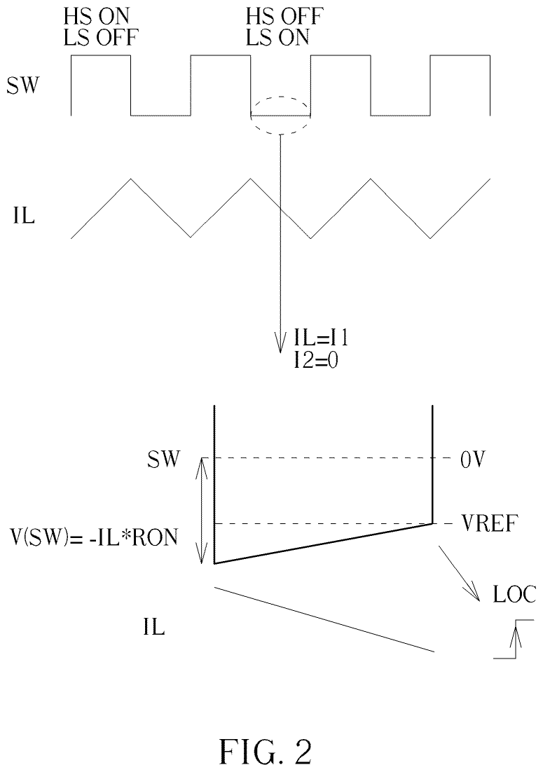

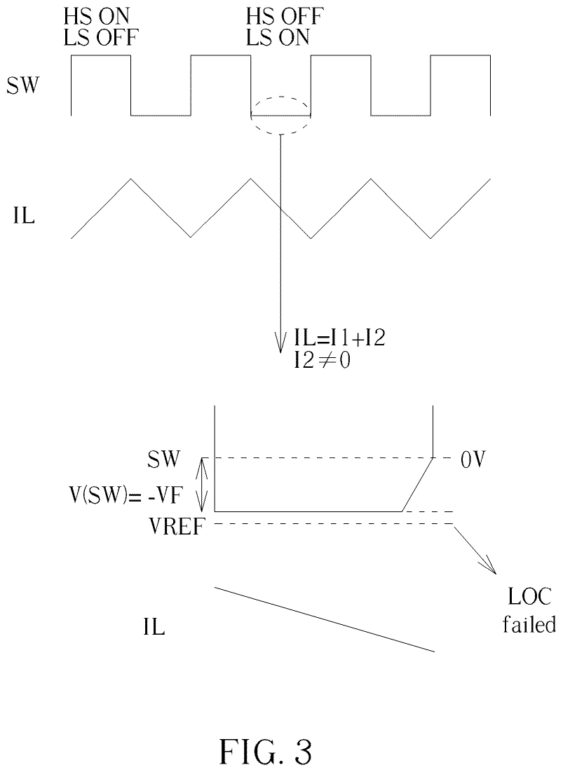

FIG. 2 is a diagram illustrating a first scenario in which the proposed adaptive adjustment of the detection threshold voltage VREF is disabled under an I2=0 condition according to an embodiment of the present disclosure. The detection threshold voltage VREF is set by a static voltage lower than the ground voltage GND=0V. At a time instant when the high-side power switch M1 is switched off and the low-side power switch M2 is switched on, the current I1 (I1=IL) starts to flow from the source terminal of the low-side power switch M2 to the drain terminal of the low-side power switch M2, resulting in a negative voltage −IL*RON at the switch node SW. When the inductor current IL gradually decreases, the voltage V(SW) at the switch node SW gradually increased. The voltage V(SW) at the switch node SW is correlated with the current I1 (I1=IL). Suppose that the current sensing signal Vₛₑₙ is obtained from monitoring a voltage drop across the low-side power switch M2. When the current sensing signal Vₛₑₙ reaches the detection threshold voltage VREF, the comparator circuit 108 makes the control signal LOC have a transition from a logic low level “0” to a logic high level “1” to indicate occurrence of an OC event. FIG. 3 is a diagram illustrating a second scenario in

which the proposed adaptive adjustment of the detection threshold voltage VREF is disabled under an I2≠0 condition according to an embodiment of the present disclosure. The detection threshold voltage VREF is set by a static voltage lower than the ground voltage GND=0V. At a time instant when the high-side power switch M1 is switched off and the low-side power switch M2 is switched on, the current I1 (I1=IL) starts to flow from the source terminal of the low-side power switch M2 to the drain terminal of the low-side power switch M2, resulting in a negative voltage −IL*RON at the switch node SW. If the current I1 (I1=IL) at this moment is large enough to make the voltage drop IL*RON larger than the forward voltage VF of the body diode 104 (i.e., IL*RON>VF), the body diode 104 is forward biased, clamping a negative voltage-VF at the switch node SW. When the inductor current IL gradually decreases, the voltage V(SW) at the switch node SW is clamped at −VF. Suppose that the current sensing signal Vₛₑₙ is obtained from monitoring a voltage drop across the low-side power switch M2. When the inductor current IL (IL=I1+I2) reaches a current limit setting, the comparator circuit 108 fails to make the control signal LOC have a transition from a logic low level “0” to a logic high level “1” to indicate occurrence of an OC event. To address the sensing error issue, the present

disclosure proposes adaptively adjusting the detection threshold voltage VREF according to temperature variation under the I2≠0 condition. It should be noted that the forward voltage VF of the body diode 104 is temperature dependent, and has a negative temperature coefficient. Hence, the body diode 104 has a lower forward voltage VF under a higher temperature, and has a higher forward voltage VF under a lower temperature. In most cases, the body diode 104 will be forward biased when the temperature is high. For example, the I2=0 condition may occur when the temperature TEMP is not higher than a pre-defined value TH (e.g., TH=125° C.), and the I2≠0 condition may occur when the temperature TEMP is higher than the pre-defined value TH (e.g., TH=125° C.). In this embodiment, the threshold voltage generator circuit 109 is configured to adaptively adjust the detection threshold voltage VREF according to temperature variation. Adaptive adjustment of the detection threshold voltage VREF is enabled only when a pre-defined condition is met. For example, the threshold voltage generator circuit 109 is configured to generate and output a static voltage as the detection threshold voltage VREF when temperature TEMP is not higher than the pre-defined value TH (e.g., TH=125° C.), and is configured to generate and output an adaptive voltage as the detection threshold voltage VREF when the temperature TEMP is higher than the pre-defined value TH (e.g., TH=125° C.). Further details of the threshold voltage generator circuit 109 are described as below with reference to the accompanying drawings.

As shown in FIG. 1, the threshold voltage generator circuit 109 includes a voltage generator circuit 110, a switch circuit 112, and a forward voltage detection circuit 114. The voltage generator circuit 110 is configured to generate and output the detection threshold voltage VREF to the comparator circuit 108. The switch circuit 112 is controlled by the temperature TEMP. For example, the temperature TEMP may be provided by a temperature sensor (not shown). The forward voltage detection circuit 114 is configured to generate an output current IBAS′ that is correlated with temperature and body diode's forward voltage.

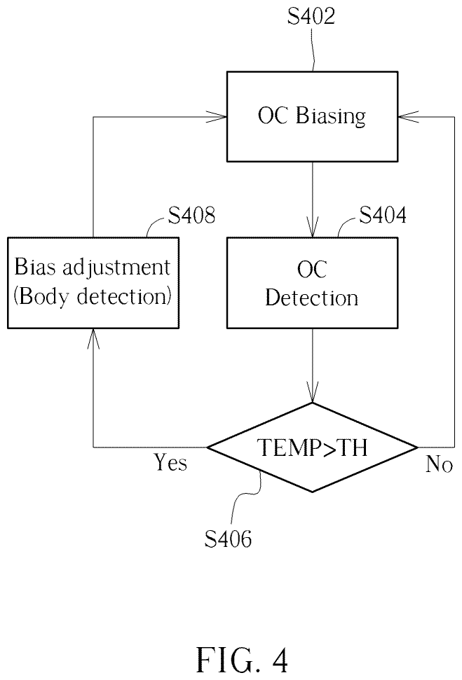

FIG. 4 is a flowchart illustrating an output current protection method according to an embodiment of the present disclosure. The output current protection method may be employed by the output current protection controller 106 shown in FIG. 1. For example, the output current protection method is performed to control whether or not an OCP function should be enabled to prevent an output current (i.e., an inductor current IL) from exceeding a current limit setting.

In step S402, the voltage generator circuit 110 generates the detection threshold voltage VREF according to a bias current IBAS. For example, the bias current IBAS may be a constant current that is temperature independent, and the detection threshold voltage VREF may be initialized by a static voltage that is also temperature independent. In step S404, the comparator circuit 108 compares the current sensing signal Vₛₑₙ with the detection threshold voltage VREF for OC detection. In step S406, an ON/OFF status of the switch circuit 112 is controlled by the temperature TEMP. For example, the switch circuit 112 may be a MOS switch with a gate voltage set by a logic high level “1” if a criterion TEMP>TH is met and set by a logic low level “0” if a criterion TEMP≤TH is met. Initially, the switch circuit 112 may be switched off to disconnect the forward voltage detection circuit 114 from the voltage generator circuit 110. When the temperature TEMP is not higher than the pre-defined value TH (e.g., TH=125° C.), the switch circuit 112 remains switched off, such that no adjustment is made to the detection threshold voltage VREF. When the temperature TEMP is higher than the pre-defined value TH (e.g., TH=125° C.), the switch circuit 112 is switched on to connect the forward voltage detection circuit 114 to the voltage generator circuit 110, such that adjustment is made to the detection threshold voltage VREF (step S408). In step S408, the forward voltage detection circuit 114 generates the output current IBAS′ that is correlated with temperature and body diode's forward voltage, and supplies the output current IBAS′ to the voltage generator circuit 110 through the switch circuit 112. In step S402, the voltage generator circuit 110 generates the detection threshold voltage VREF which is adaptively adjusted in response to the output current IBAS′. For example, the detection threshold voltage VREF may be set according to the output current IBAS′, where the output current IBAS′ (which is temperature dependent) may take the place of the original bias current IBAS (which is temperature independent). For another example, the detection threshold voltage VREF may be set by jointly considering the bias current IBAS and the output current IBAS′, where the output current IBAS′ (which is temperature dependent) may serve as a decrement applied to the bias current IBAS (which is temperature independent). To put it simply, any voltage generator circuit using the output current IBAS′ (which is correlated with temperature and body diode's forward voltage) to achieve adaptive adjustment of the detection threshold voltage VREF falls within the scope of the present disclosure.

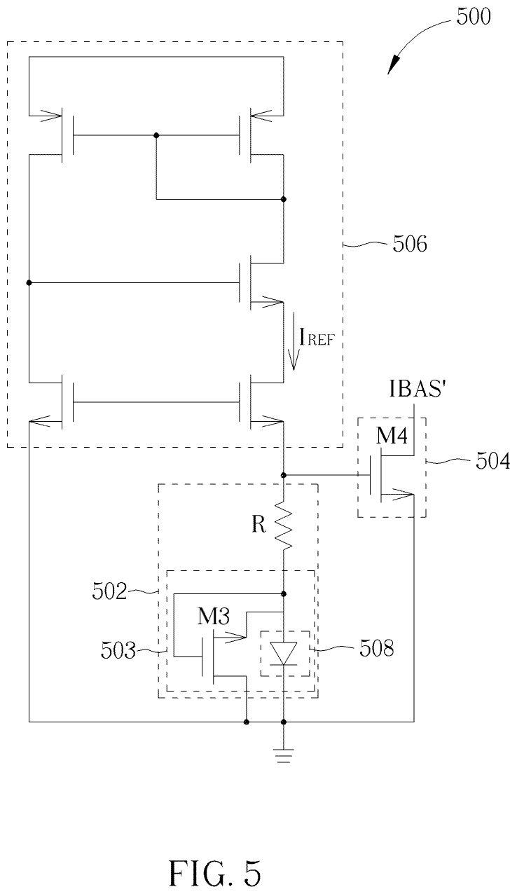

FIG. 5 is a diagram illustrating a forward voltage detection circuit according to an embodiment of the present disclosure. The forward voltage detection circuit 114 shown in FIG. 1 may be implemented using the forward voltage detection circuit 500 shown in FIG. 5. In this embodiment, the forward voltage detection circuit 500 includes a voltage detection path 502, an output current generator circuit 504, and a reference current generator circuit 506. In this embodiment, the voltage detection path 502 includes a resistor R and a body detection circuit 503 (which is implemented by an NMOS transistor M3) connected in series. The reference current generator circuit 506 is coupled to the voltage detection path 502, and is configured to generate a reference current I_{REF} flowing through the voltage detection path 502. For example, the reference current generator circuit 506 may be implemented using a current mirror circuit or any circuit source capable of providing the reference current I_{REF}. The body detection circuit 503 is configured to provide a voltage drop indicative of a forward voltage VF_{M3} of a body diode 508 of the NMOS transistor M3. Specifically, a gate terminal of the NMOS transistor M3 is coupled to a source terminal of the NMOS transistor M3, and a drain terminal of the NMOS transistor M3 is coupled to the ground voltage GND=0V. Since an anode of the body diode 508 is coupled to the source terminal of the NMOS transistor M3 and a cathode of the body diode 508 is coupled to the drain terminal of the NMOS transistor M3, the body diode 508 is forward biased when the reference current I_{REF} flows through the voltage detection path 502. Hence, a voltage drop across the voltage detection path 502 is equal to I_{REF}*R+VF_{M3}.

Consider a case where the current sensing circuit 105 has a sensing MOS transistor (e.g., an NMOS transistor), where a gate terminal of the sensing MOS transistor (e.g., NMOS transistor) may be coupled to a gate terminal of the low-side power switch (e.g., NMOS transistor) M2, and a drain terminal of the sensing MOS transistor (e.g., NMOS transistor) may be coupled to a drain terminal of the low-side power switch (e.g., NMOS transistor) M2. In this embodiment, a type of a MOS transistor (e.g., NMOS transistor M3) used for body detection may be the same as a type of a sensing MOS transistor (e.g., NMOS transistor) involved in current sensing of the output current (i.e., inductor current IL) of the switching regulator circuit 100. In this way, the temperature-dependent forward voltage of the low-side power switch (e.g., NMOS transistor) M2 can be more accurately estimated using the temperature-dependent forward voltage of the MOS transistor (e.g., NMOS transistor M3) used by the body detection circuit 503.

The output current generator circuit 504 is coupled to the voltage detection path 502, and is configured to generate the output current IBAS′ that is correlated with a voltage drop of the body detection circuit 503 (particularly, a voltage drop indicative of the forward voltage VF_{M3} of the body diode 508 of the NMOS transistor M3). In this embodiment, the output current generator circuit 504 is implemented using an NMOS transistor M4, where a gate terminal and a source terminal of the NMOS transistor M4 are coupled to two ends of the voltage detection path 502, respectively, and the output current IBAS′ is output at a drain terminal of the NMOS transistor M4. As shown in FIG. 5, a gate-to-source voltage V_{GS} of the NMOS transistor M4 is set by the voltage drop I_{REF}*R+VF_{M3} across the voltage detection path 502. Hence, the output current IBAS′ increases when the forward voltage VF_{M3} increases due to temperature rise, and the output current IBAS′ decreases when the forward voltage VF_{M3} decreases due to temperature drop. In this way, the voltage generator circuit 110 can refer to the temperature-dependent output current IBAS′ to apply different adjustments to the detection threshold voltage VREF under different temperatures that are higher than the pre-defined value TH (e.g., TH=125° C.). The sensing error issue can be addressed by the proposed adaptive adjustment of the detection threshold voltage VREF that is enabled under an I2≠0 condition.

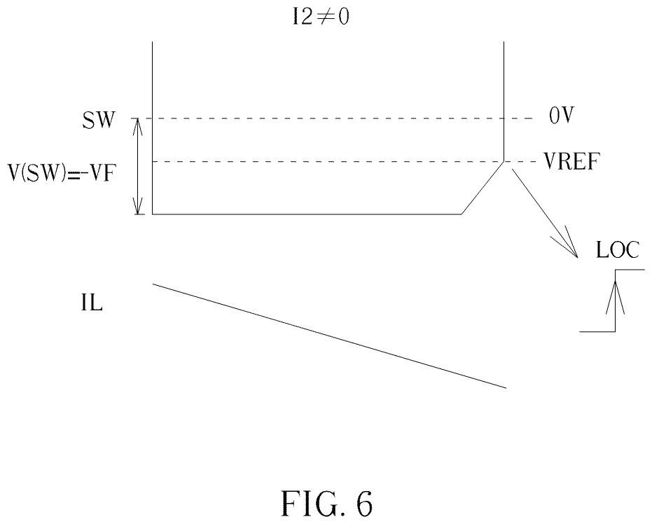

FIG. 6 is a diagram illustrating a third scenario in which the proposed adaptive adjustment of the detection threshold voltage VREF is enabled under an I2≠0 condition according to an embodiment of the present disclosure. Compared to the detection threshold voltage VREF (which is a static voltage) shown in FIG. 2, the detection threshold voltage VREF (which is an adaptive voltage) shown in FIG. 6 is adjusted to a higher voltage level below 0V. At a time instant when the high-side power switch M1 is switched off and the low-side power switch M2 is switched on, the current I1 (I1=IL) starts to flow from the source terminal of the low-side power switch M2 to the drain terminal of the low-side power switch M2, resulting in a negative voltage −IL*RON at the switch node SW. If the current I1 (I1=IL) is large enough to make the voltage drop IL*RON larger than the forward voltage VF of the body diode 104 (i.e., IL*RON>VF), the body diode 104 is forward biased, clamping a negative voltage −VF at the switch node SW. Suppose that the current sensing signal Vₛₑₙ is obtained from monitoring a voltage drop across the low-side power switch M2. When the temperature gradually rises, the voltage V(SW) at the switch node SW gradually increased due to the forward voltage VF with a negative temperature coefficient. When the current sensing signal Vₛₑₙ reaches the detection threshold voltage VREF (which is set by a higher voltage level below 0V), the comparator circuit 108 makes the control signal LOC have a transition from a logic low level “0” to a logic high level “1” to indicate occurrence of an OC event. With the help of the proposed adaptive adjustment of the detection threshold voltage VREF, the OCP function still works properly under the I2≠0 condition.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An output current protection controller comprising:
a comparator circuit, configured to compare a current sensing signal with a detection threshold voltage to generate a control signal that controls output current protection of a switching regulator circuit, wherein the current sensing signal is indicative of an output current of the switching regulator circuit; and
a threshold voltage generator circuit, configured to adaptively adjust the detection threshold voltage according to temperature variation.

2. The output current protection circuit of claim 1, wherein the threshold voltage generator circuit is configured to generate and output a static voltage as the detection threshold voltage when temperature is not higher than a pre-defined value, and is configured to generate and output an adaptive voltage as the detection threshold voltage when the temperature is higher than the pre-defined value.

3. The output current protection circuit of claim 1, wherein the threshold voltage generator circuit comprises:
a forward voltage detection circuit, comprising:
a voltage detection path, comprising:
a body detection circuit, configured to provide a voltage drop indicative of a forward voltage of a body diode of a first metal-oxide-semiconductor (MOS) transistor; and
an output current generator circuit, coupled to the voltage detection path, wherein the output current generator circuit is configured to generate an output current correlated with the voltage drop; and
a voltage generator circuit, configured to generate and output the detection threshold voltage according to the output current.

4. The output current protection circuit of claim 3, wherein the forward voltage detection circuit further comprises:
a reference current generator circuit, coupled to the voltage detection path, wherein the reference current generator circuit is configured to generate a reference current flowing through the voltage detection path; and
the voltage detection path further comprises:
a resistor, coupled to the body detection circuit in series.

5. The output current protection circuit of claim 4, wherein the body detection circuit comprises the first MOS transistor, a gate terminal of the first MOS transistor is coupled to a source terminal of the first MOS transistor, and the reference current flows from the source terminal to a drain terminal of the first MOS transistor.

6. The output current protection circuit of claim 3, wherein a sensing MOS transistor is involved in current sensing of the output current of the switching regulator circuit, and the first MOS transistor and the sensing MOS transistor are MOS transistors of a same type.

7. The output current protection circuit of claim 3, wherein the output current generator circuit comprises:
a second MOS transistor, wherein a gate terminal and a source terminal of the second MOS transistor are coupled to two ends of the voltage detection path, respectively, and the output current is output at a drain terminal of the second MOS transistor.

8. The output current protection circuit of claim 1, wherein the output current protection is over current protection (OCP).

9. The output current protection circuit of claim 1, wherein the switching regulator circuit is a buck converter circuit.

10. The output current protection circuit of claim 9, wherein the buck converter circuit comprises a high-side power switch and a low-side power switch, and the current sensing signal is generated when the high-side power switch is switched off and the low-side power switch is switched on.

11. An output current protection method comprising:
comparing a current sensing signal with a detection threshold voltage to generate a control signal that controls output current protection of a switching regulator circuit, wherein the current sensing signal is indicative of an output current of the switching regulator circuit; and
adaptively adjusting the detection threshold voltage according to temperature variation.

12. The output current protection method of claim 11, further comprising:
when the temperature is not higher than a pre-defined value, generating a static voltage as the detection threshold voltage;
wherein adaptively adjusting the detection threshold voltage according to temperature variation comprises:
when the temperature is higher than the pre-defined value, generating an adaptive voltage as the detection threshold voltage.

13. The output current protection method of claim 11, wherein adaptively adjusting the detection threshold voltage according to temperature variation comprises:
providing a voltage detection path which comprises a first metal-oxide-semiconductor (MOS) transistor, wherein the voltage detection path generates a voltage drop indicative of a forward voltage of a body diode of the first MOS transistor;
generating an output current correlated with the voltage drop; and
generating the detection threshold voltage according to the output current.

14. The output current protection method of claim 13, wherein the voltage detection path further comprises a resistor coupled to the first MOS transistor in series, and adaptively adjusting the detection threshold voltage according to temperature variation further comprises:
generating a reference current flowing through the voltage detection path.

15. The output current protection method of claim 14, wherein a gate terminal of the first MOS transistor is coupled to a source terminal of the first MOS transistor, and the reference current flows from the source terminal to a drain terminal of the first MOS transistor.

16. The output current protection method of claim 13, wherein a sensing MOS transistor is involved in current sensing of the output current of the switching regulator circuit, and the first MOS transistor and the sensing MOS transistor are MOS transistors of a same type.

17. The output current protection method of claim 13, wherein generating the output current correlated with the voltage drop comprises:
utilizing a second MOS transistor with a gate terminal and a source terminal coupled to two ends of the voltage detection path, respectively;
generating the detection threshold voltage according to the output current comprises:
generating the detection threshold voltage according to the output current obtained from a drain terminal of the second MOS transistor.

18. The output current protection method of claim 11, wherein the output current protection is over current protection (OCP).

19. The output current protection method of claim 11, wherein the switching regulator circuit is a buck converter circuit.

20. The output current protection method of claim 19, wherein the buck converter circuit comprises a high-side power switch and a low-side power switch, and the current sensing signal is generated when the high-side power switch is switched off and the low-side power switch is switched on.
